(19) United States
(12) Patent Application Publication
(10) Pub. No.: US 2023/0328592 A1
(43) Pub. Date: Oct. 12, 2023

(54) SPLIT OPTION SWITCHING METHODS AND APPARATUS

(71) Applicant: Celona, Inc., Cupertino, CA (US)

(72) Inventors: Shashideep Nuggehalli, Cupertino, CA (US); Satish Ananthaiyer, Cupertino, CA (US); Srinivasan Balasubramanian, San Diego, CA (US)

(21) Appl. No.: 17/842,686

(22) Filed: Jun. 16, 2022

Related U.S. Application Data
(60) Provisional application No. 63/328,199, filed on Apr. 6, 2022.
(60) Provisional application No. 63/337,001, filed on Apr. 29, 2022.

(51) Int. Cl. H04W 28/08; H04W 28/02

(52) U.S. Cl. CPC H04W 28/0933; H04W 28/0268; H04W 28/0958; H04L 43/0864

(57) ABSTRACT

Methods and apparatus relating to dynamically switching between split-option architectures of wireless networks based on real-time and non-real-time measurements and inputs wherein the split-option architectures are switched to optimize user equipment (UE) experiences and network performance are disclosed.

### CLAIMS OF PRIORITY TO PREVIOUSLY FILED PROVISIONAL APPLICATIONS AND REFERENCE TO RELATED UTILITY APPLICATION—INCORPORATION BY REFERENCE

This non-provisional application (ATTY. DOCKET NO. CEL-057-PAP) claims priority to earlier-filed provisional application No. 63/328,199 filed Apr. 6, 2022, entitled “Split Option Switching Methods and Apparatus” (ATTY. DOCKET NO. CEL-057-PROV); and this non-provisional application also claims priority to earlier-filed provisional application No. 63/337,001 filed Apr. 29, 2022, entitled “Split Option Switching Methods and Apparatus” (ATTY DOCKET NO. CEL-057-PROV-2); and this non-provisional application is also related to US utility application number 17,549,603 (non-provisional application) filed Dec. 13, 2021, entitled “Load Balancing for Enterprise Deployments” (ATTY. DOCKET NO. CEL-050-PAP); and the contents of the above-cited earlier-filed provisional applications (App. No.: 63/328,199 filed Apr. 6, 2022 and App. No. 63/337,001 filed Apr. 29, 2022), and the earlier-filed non-provisional application (application number 17,549,603 filed Dec. 13, 2021) are all hereby incorporated by reference herein as if set forth in full.

### BACKGROUND

### (1) Technical Field

The disclosed methods and apparatus relate generally to wireless communication networks, and in particular, the disclosed methods and apparatus relate to dynamically switching between split-option architectures of wireless networks based on real-time and non-real-time measurements and inputs wherein the split-option architectures are switched to optimize user equipment (UE) experiences and network performance.

### (2) Background

The wireless industry has experienced tremendous growth in recent years. Wireless technology is rapidly improving, and faster and more numerous broadband communication networks have been installed around the globe. These networks have now become key components of a worldwide communication system that connects people and businesses at speeds and on a scale unimaginable just a couple of decades ago. The rapid growth of wireless communication is a result of increasing demand for more bandwidth and services. This rapid growth is in many ways supported by standards. For example, 4G LTE has been widely deployed over the past years, and the next generation system, 5G NR (New Radio) is now being deployed. In these wireless systems, multiple mobile devices are served voice services, data services, and many other services over wireless connections so they may remain mobile while still connected.

It is commonplace today for communications to occur over a wireless network in which user equipment (UE) connects to the network via a wireless transceiver, such an eNodeB, gNodeB, access point or base station, hereafter referred to generically as a BS/AP (base station/Access Point). In this disclosure the term eNodeB is shortened to the term “eNB” or “gNB” and is used generically to refer to the following: a single sector eNB/gNB; a dual sector eNB/gNB, with each sector acting independently; and a node that supports both eNB and gNB functions. The UE may be a wireless cellular telephone, tablet, computer, Internet-of-Things (IoT) device, or other such wireless equipment. The BS/AP may be an eNodeB (“eNB”) as defined in 3GPP specifications for long term evolution (LTE) systems (sometimes referred to as 4th Generation (4G) systems) or a gNodeB as defined in 3GPP specifications for new radio (NR) systems (sometimes referred to as 5G systems). Furthermore, the BS/AP may be a single sector node or a dual sector node in which each of two sectors act independently. In 4G and 5G systems, there are times when a relatively large number of UEs may be attempting to access the network through the same “cell”.

In many cases, there is a mix of UEs, some requiring high throughput with data arriving in bursts and other UEs requiring minimal throughput, but having frequent data transmit and receive requirements. The term ‘BS/AP” is used broadly herein to include base stations and access points, including at least an evolved NodeB (eNB) of an LTE network or gNodeB (gNB) of a 5G network, a cellular base station (BS), a Citizens Broadband Radio Service Device (CBSD) (which may be an LTE or 5G device), a Wi-Fi access node, a Local Area Network (LAN) access point, a Wide Area Network (WAN) access point, and should also be understood to include other network receiving hubs that provide access to a network of a plurality of wireless transceivers within range of the BS/AP. Typically, the BS/APs are used as transceiver hubs, whereas the UEs are used for point-to-point communication and are not used as hubs. Therefore, the BS/APs transmit at a relatively higher power than the UEs.

FIG. 1 is an illustration of components of a wireless communications network 100. In some embodiments, the communications network 100 comprises a Radio Access Network (RAN). It is commonplace today for communications to occur over a wireless network in which user equipment (UE) (such as, for example, UEs 101a, 101b, 101c, and 101d) connect to the network via a wireless transceiver, such an eNodeB (eNB), gNodeB (gNB), Access Point (or base station) 103, hereafter referred to generically as a BS/AP (base station/Access Point) or more simply, an Access Point (AP) 103. A wireless device operated by a user, commonly referred to as a “User Equipment” (UE), is typically in wireless communication with the Access Point (AP) 103, or, more specifically, via a base station antenna 130. Although only a single AP 103 is shown in FIG. 1, several APs 103 are used to communicate with a plurality of UEs in typical communication network 100 deployments.

As shown in FIG. 1, the BS/AP 103 (or a plurality of BS/APs 103 which are not shown in FIG. 1 for simplicity's sake) communicate with an Edge Node 120. The Edge Node 120 communicates with the other components of the RAN 100 and the RAN Core Network 114, and allows users of the various UEs 101 access to services provided by the RAN 100 including those provided by the Internet 107. In some embodiments, the RAN Core Network 114 comprises a 5G Core Network (5GC).

As described in more detail below with reference to FIG. 2, in some embodiments, the RAN gNBs 103 incorporate 3 main functional modules or components: a Centralized (or “Central”) Unit (CU), a Distributed Unit (DU), a Radio Unit (RU). In some embodiments, the RU comprises a radio hardware unit that coverts radio signals sent to and from a base station antenna into a digital signal for transmission over packet networks. In some embodiments, the RU processes a digital front end (DFE) and a lower PHY layer, as well as digital beamforming functionality. 5G RU designs are typically designed to be “inherently” intelligent, but important considerations of RU design are size, weight, and power consumption. In some embodiments, the DU is deployed in close proximity to the RU. In other deployments, the DU is deployed physically distant from the RU, in which case the RU is considered a Remote RU, or RRU for short. In some deployments, the DU runs the RLC, MAC, and parts of the PHY layer. The DU node includes a subset of the eNodeB (eNB)/gNodeB (gNB) functions, depending on the functional split option, and its operation is controlled by the CU. The CU typically runs a Radio Resource Control (RRC) and Packet Data Convergence Protocol (PDCP) layers. The split option RAN architectures allow a 5G network to utilize different distributions of protocol stacks between CUs and DUs.

RAN deployments can be implemented and deployed in different ways using different architectures to meet system demands and to satisfy user demands and experiences. The 5G RAN has a number of architecture options, such as how to split RAN functions, where to place those functions, and what transport is used to interconnect them. The BS/AP 103 can be deployed as a monolithic unit deployed at a cell site, as in cellular networks, or split between the CU, DU, RU and RRUs. The CU-DU split is typically a higher layer split (HLS), which is more tolerant to delay. The DU-RU interface is a lower-layer split (LLS), which is more latency-sensitive and demanding on bandwidth. CUs, DUs, RUs, and RRUs may be deployed at locations such as cell sites (including towers, rooftops and associated cabinets and shelters), transport aggregation sites and “edge sites” (for example, central offices or local exchange sites).

The type of RAN architecture to use and the placement of the CU, DU, RU and RRU nodes within the RAN network depends upon the needs of the RAN operator and its users. Trade-offs are not clear cut, and different architectures have advantages and disadvantages in terms of latency, jitter, and bandwidth between the RAN and the UEs it services. Usage patterns, device capabilities, operating costs, RF strategies, and existing RF network footprints and capabilities influence network architecture decisions. RAN functional split-options (splitting the functions of the CU and DU) provide alternative RAN network architectures and alternative RAN network deployments.

In some embodiments, the gNB comprises a CU and at least one DU connected to the CU. A CU with multiple DUs support multiple gNBs. The functional split architecture lets a 5G network utilize different distributions of protocol stacks between CUs and DUs depending on mid-haul availability and network design. In some embodiments, the CU is a logical node that includes the gNB functions such as transfer of user data, mobility control, RAN sharing (MORAN), positioning, session management etc., except for functions that are exclusively allocated to the DU. In some embodiments, the CU controls the operation of several DUs over a mid-haul interface. As described in more detail below, the CU can, in some embodiments, be co-located on the same site as the DU, or located at a distance away from the DU.

In typical, or “normal” types of deployments, the base station functionality, or the AP functionality, is either concentrated in a specific place, or it is essentially split in a defined way throughout the RAN (Radio Access Network) network. Various split-options are well-defined for the 5G RAN architectures. Currently there are eight (8) different and distinct functional split-options specified in the standards. These functional split-options include split-option 1, 2, 3, 4, 5, 6, 7.1, 7.2, 7.2x (wherein the “x” stands for “a” or “b”) and 8. As is described in greater detail below, the present split-option switching methods and apparatus primarily focus on split options 2, 6, and 7.2x, but these are exemplary and the presently disclosed split-option switching methods and apparatus are not limited to just these the functional split-options described and shown in the figures. The split of functionality and physical locations essentially and primarily are between three components or nodes—the RU (Radio Unit), the DU and the CU. Which functions of the RAN (Radio Access Network) performed by these three nodes are defined in and by the different split-options set forth in the functional split-option specifications.

As noted above, RAN network logical architectures, such as the RAN 100 of FIG. 1, can be implemented and deployed in many different ways, according to an operator's requirements and preferences, and to satisfy UE experiences. FIG. 2 shows a block diagram of exemplary deployments of a RAN network 200 and showing various possible physical placements of the RU, DU and CU functionality throughout the RAN network 200. The RAN 200 shown in FIG. 2 is for explanatory purposes only and should not be interpreted as actual (“real world”) RAN deployments. As shown in FIG. 2, three different versions of BS/APs (BS/AP v1 202, BS/AP v2 204 and BS/AP v3 206) are shown at the bottom of the figure. As shown in FIG. 2, the AP can be deployed as a monolithic “all-in-one”unit deployed at a cell site, as in classic cellular networks, such as in the BS/AP v2 204 of FIG. 2. As shown thereat, the BS/AP v2 204 co-locates the RU 210′ with the DU 212′ and the CU 214. Alternatively, the CU, DU and RU can be split away from being implemented as a monolithic “all-in-one” cell site as shown in the BS/AP v1 202 and BS/AP v3 206. BS/AP v1 202 includes the RU 210 co-located with the DU 212, whereas the BS/AP v3 206 includes only a Remote RU (RRU) 210″, so named because it is located at a distance (remote) from the DU. Other RRUs (208a, 208b, and 208c) are also shown in the RAN 200 of FIG. 2, and these RRUs 208 also communicate with the DU 212.

As shown in FIG. 2, all of the APs 202, 204 and 206 communicate with the Edge Node 120 (as is also shown in FIG. 1). Depending on the type of AP, and more specifically, depending on whether the AP 202, 204 or 206, includes a DU or CU, the AP communicates with either a DU that is off-loaded to the Edge Node 120 or a CU located somewhere within the RAN 200. For example, the AP v1 202 DU 212 communicates with the CU 214′ located in the Edge Node 120a. The AP v3 206 communicates with the DU 212″ and the CU 214″ located in the Edge Node 120c. The RAN 200 of FIG. 2 also demonstrates that the CU can be implemented and deployed in different nodes and locations within the RAN 200 as shown in FIG. 2. For example, the CU 214 is located within a monolithic, integrated, and centrally located AP 204. However, the CU can optionally be offloaded and located in the Edge Node 120 (such as the CU 214′ in the Edge Node 120a, or the CU 214″ and DU 212″ combination located in the Edge Node 120c). Alternatively, the CU 214′″ can be located between the Edge Node 120 and the RAN Core Network 114. So, as can be seen, the CU and DU can be co-located with the RU or physically distanced therefrom in some embodiments.

Typical RAN network deployments chose which functional split-option to implement and deploy their networks accordingly. The architecture that is deployed is therefore static, and disadvantageously does not adapt to UE and user needs and experiences. Therefore, there is a need for a dynamic split-option architecture wherein split-option deployments are dynamically switched from one split-option to another to meet UE needs and user experiences. Typical RAN architectures do not have this dynamic capability. The present split-option switching methods and apparatus provides such flexibility. It provides an ability to move instances of the CU and DU to better facilitate the end users' experiences.

### BRIEF DESCRIPTION OF THE DRAWINGS

The disclosed method and apparatus, in accordance with one or more various embodiments, is described with reference to the following figures. The drawings are provided for purposes of illustration only and merely depict examples of some embodiments of the disclosed method and apparatus. These drawings are provided to facilitate the reader's understanding of the disclosed method and apparatus. They should not be considered to limit the breadth, scope, or applicability of the claimed invention. It should be noted that for clarity and ease of illustration these drawings are not necessarily made to scale.

FIG. 1 shows an illustration of components of a wireless communications network.

FIG. 2 is a block diagram of exemplary deployments components of an exemplary RAN network showing various possible physical placements of the RU, DU and CU functionality throughout the RAN network.

FIG. 3 shows a first architectural variant of an AP that can be utilized to implement the split-option switching methods and apparatus of the present disclosure.

FIG. 4 shows a second architectural variant of an AP that can be utilized to implement the split-option switching methods and apparatus of the present disclosure.

FIG. 5 shows a block diagram of an exemplary network deployment that can be used in implementing the present split-option splitting methods and apparatus.

FIG. 5A shows a block diagram of an another exemplary network deployment that can be used in implementing the present split-option splitting methods and apparatus.

FIG. 6 shows an exemplary software flowchart of a method that can be used in implementing the split-option switching methods and apparatus of the present disclosure.

FIG. 6A shows another exemplary software flowchart of a method that can be used in implementing the split-option switching methods and apparatus of the present disclosure. This flowchart is very similar to that shown in FIG. 6.

FIG. 7 shows an exemplary software flowchart showing an HO procedure when handing over from a low power RU to a high power RU.

FIG. 7A shows an exemplary software flowchart showing an HO procedure when handing over from a low power RRU to a high power RRU.

FIGS. 8-11, inclusive, show exemplary software flowcharts that may be used to implement the present Load Balancing feature of the present Split Option Switching Methods and Apparatus.

The figures are not intended to be exhaustive or to limit the claimed invention to the precise form disclosed. It should be understood that the disclosed method and apparatus can be practiced with modification and alteration, and that the invention should be limited only by the claims and the equivalents thereof.

### DETAILED DESCRIPTION

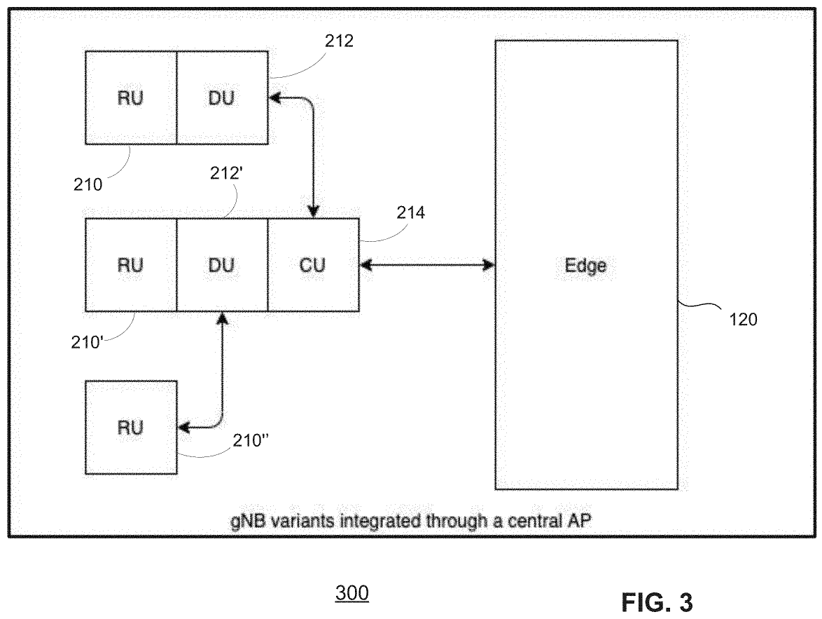

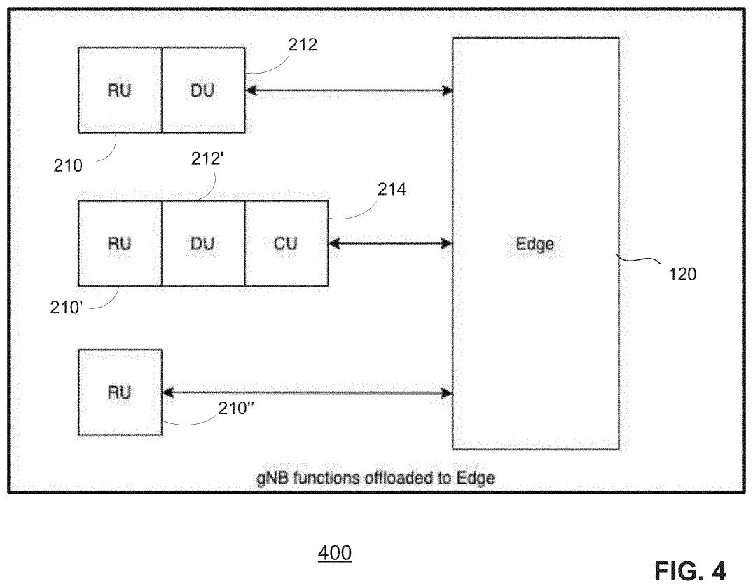

Referring now to FIGS. 3 and 4, various architectural variants of APs that can be utilized to implement the split-option switching methods and apparatus of the present disclosure. Two architectural variants are shown in FIGS. 3 and 4. As shown in the first architectural variant 300 of FIG. 3, the gNB variant is integrated through a central AP. This architectural variant 300 includes an RU 210″, an RU 210′ and an RU 210. FIG. 3 captures functional split-option 7.2 wherein an RU is attached to a DU. The RU 210 acts in combination with a DU 212. The DU 212 is controlled by and is in communication with a CU 214. The fully integrated CU/DU/RU combination comprises the CU 214, a DU 212′, and an RU 210′. Finally, the RU 210″ communicates with the DU 212′. The CU 214 controls all three sub-variants of the first variant 300 architecture: the DU/RU sub-variant, the integrated CU/DU/RU sub-variant, and the RU 210″ sub-variant. The CU 214 communicates with the Edge Node 120 as shown in FIG. 3. Technically, the RU 210″ is, in truth, a remote RU (RRU) as it is located separate from the DU 212′.

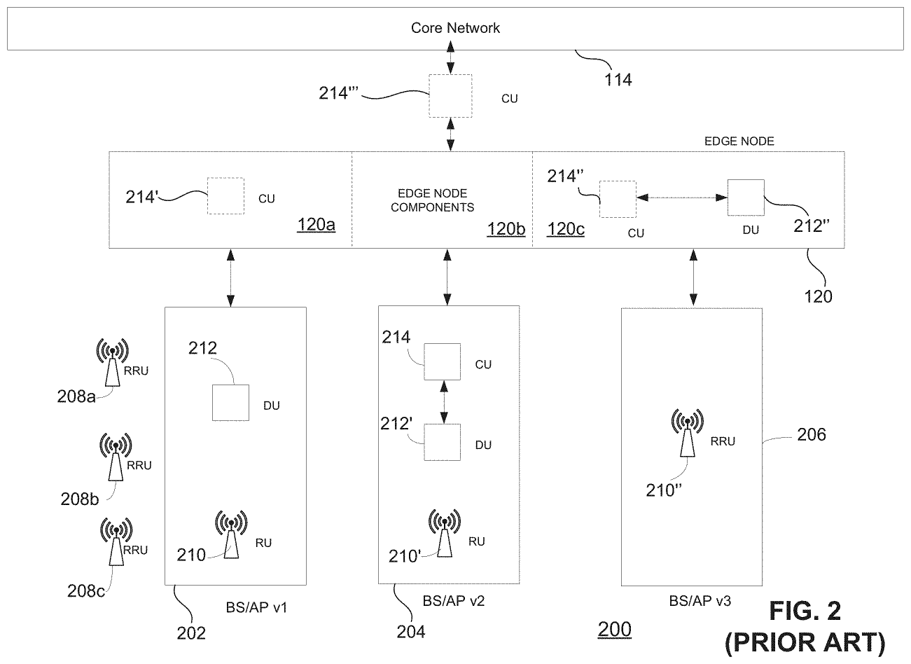

A second architectural variant 400 of an AP architecture is shown in FIG. 4. In the second variant 400 of FIG. 4, the gNB functions are offloaded to the Edge Node 120. As with the first architectural variant 300 of FIG. 3, the second architectural variant 400 includes an RU 210″, an RU 210′ and an RU 210. The RU 210 acts in combination with the DU 212. The DU 212 is controlled by and is in communication with a CU (not shown), wherein the CU is typically located in the Edge Node 120 or beyond. The fully integrated CU/DU/RU combination comprises the CU 214, the DU 212′, and the RU 210′. Finally, the RU 210″ (or, more specifically, the RRU 210″) communicates with a DU typically located in the Edge Node 120 (such as the DU 212″ of FIG. 2). This DU is controlled by a CU such as, for example, the CU 214″ shown in the Edge Node 120c of FIG. 2. The CU 214 node controls all three sub-variants of the second variant 400 architecture: the DU/RU sub-variant, the integrated CU/DU/RU sub-variant, and the RU 210″ sub-variant.

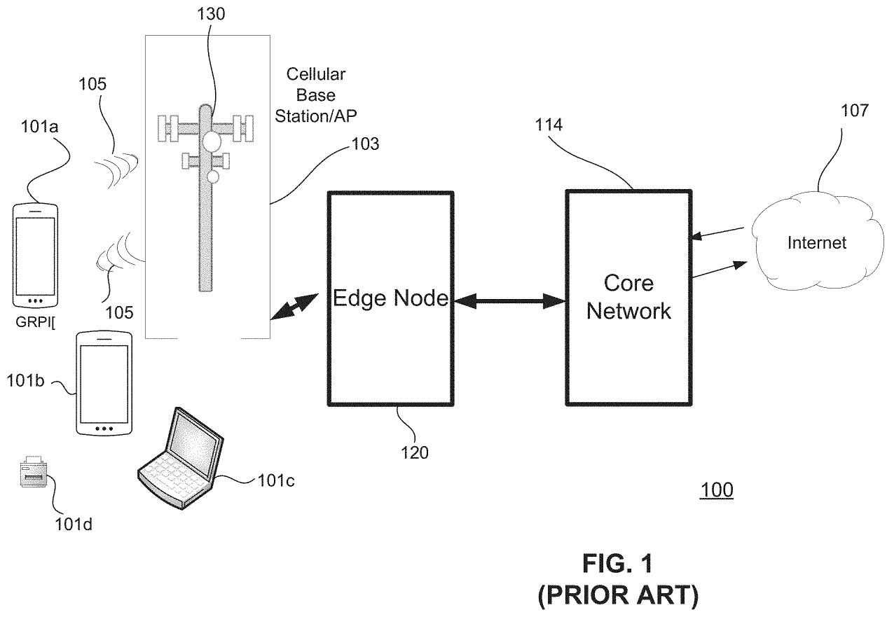

As described in the Background section above, prior art RAN network deployment typically use static versions of the functional split-options shown in FIGS. 1-4. The split-options are fixed in these prior art implementations, and are not capable of dynamically switching based upon changes in the network performance and UE needs and experiences. The entire RAN network disadvantageously uses a selected functional split and is not capable of switching to meet user needs.

In contrast, the present split-option switching methods and apparatus described herein is dynamic, and changes depending on both the network needs and on the users' needs, at a very high level. The architectural sub-variant of FIG. 3 that has DU 212 and RU 210 coupled together is specified in Split-Option 6. The architectural sub-variant that has DU 212′/CU 214 coupled to the lone RU 210″ is referred to as Split Option 7.2x. Where the “x” can stand for .a or .b. as described above.

Depending on a given situation, and depending on the functionality, Quality of Experience to be delivered, as shown in the sub-variants of the architectural variant 300 shown in FIG. 3, either the entire functionality gets “modified” and implemented as a specific sub-variant, or a unique context more importantly, are moved to specific sub-variants.

FIG. 4, or the second architectural variant 400, shows an AP variant wherein gNB functions are “offloaded” to Edge Node 120. Note that the CU 214 appears in the center of the architecture of variant 400 (not on the top or on the bottom). Note further that the DUs (212, 212′) and CU 214 are not shown specifically on the bottom part of the figure. This essentially means that those functionalities may be located elsewhere. Those functionalities can be shifted and some of the contexts moved into a “central” variant, wherein it is realized by a “centralized” DU and CU in order to maintain the quality of experience to the UEs and their users.

There is potentially a third architectural variant which is neither shown in the figures nor described in greater detail herein. This variant is similar to that shown in FIG. 2, BS/AP v2 204, wherein the RU 210′, DU 212′ and CU 214 are co-located. The RU 210′ can, in some embodiments, be split into a remote RU (RRU). An intermixing of different variants is contemplated in this disclosure and may be used to implement the present split-option switching methods and apparatus.

In one example, a given network deployment 100, 200, will support one of the two architecture variants shown in FIGS. 3 and 4. The UE transitions across the RU/DU/CU that are deployed in the network. The presently disclosed split-option switching methods and apparatus provides means for UEs to seamlessly transition across these three nodes (CU, DU and RU) within a network deployment. These are transitions of control of the UE to the CU/DU/RU, and the UEs are physically moving through the RAN.

In some embodiments, this can be conceived as a network handover (HO), wherein a UE moves from a RU/DU combination of nodes, to a RU/DU/CU combination of nodes. The context is handed over to the RU/DU/CU combination. In these embodiments, the context that was maintained in the Core Network, 114, where the CU entity was sitting in the Core 114 for the RU/DU combination, moves to the RU/DU/CU combination. The context thereafter resides there (in the RU/DU/CU combination), the PFC load reduces, and the UE needs are met.

Moving instances of the CU and DU to better facilitate the end users' experiences is both novel and nonobvious in light of the prior art, and provides tremendous advantages over the prior art static deployments. As noted above, the prior art network deployments do not have this capability as they are static and fixed after deployment. In accordance with the disclosed split-option switching methods and apparatus, the instances of the CU and DU nodes may be moved within the RAN to optimize the quality of experience of the UEs.

Typically, in order to improve network performance and maximize the quality of experience at the UEs, an important goal is to put the functionality (RU/DU/CU) closest to the device (UE) that it is going to be interacting with a majority of the time. The user (UE) is closest to the Radio Unit (RU). The context of the DU and CU is brought closer to the Edge Node 120 if the requirement of a particular UE requires it, due to the flow that the particular UE demands. As a result, everything is moved over. Ultimately, the network is dynamically adapted to the needs and experiences of the user (UE). Performance concerns include latency, performance, load balancing (for example, if there are there too many users) across the Edge Node 120 and the other nodes. It is possible to perform load balancing between two different architectures. This load balancing may be performed not necessarily due to a difference between the two different architectures, but rather to simply provide load balancing of one architecture as compared with the other. In other words, the load balancing may be performed to achieve a more appropriate load balance between the two different architectures.

Load balancing—in this context, the term “load balancing” refers to balancing the number of UEs that are handled by any one particular architecture. Or more to the point, balancing the amount of flow that goes through any one particular architecture. In some embodiments, a selected node is power-efficient, and it may be optimized for power. Consequently, in these embodiments, the node cannot handle more than a certain number of users. Therefore, if the capacity increases for this particular node, it can dynamically shift some of the functionality over to the Edge Node 120 so it can then accommodate more users. This is one application of the present split option switching methods and apparatus. Alternatively, if it is desired to optimize performance, the “middle” completely integrated implementation (as shown in BS/AP v2 204 for example of FIG. 2) would be used to implement the connection to the UEs. Exemplary Load Balancing methods and apparatus are described below in greater detail with reference to the figures.

### Enhancements and Functionality Addressed by the Present Split Option Switching Methods and Apparatus:

The main characteristic and functionality addressed by the present split option switching methods and apparatus of the present disclosure is to dynamically switch a 5G access network to support operation across different possible network architecture splits. The following problems are additionally addressed by the present split option switching methods and apparatus:
(1) Call continuum in an indoor environment without handover;
(2) Increasing cell radius in environments where fading and interference margins are not constant;
(3) Call continuum across indoor and outdoor enterprises when there is adjacent deployment—this is a case when indoor and outdoor deployments of networks are present—whereby the indoor and outdoor network deployments abut each other with non-trivial overlap. In these deployments, the Edge nodes on the outdoor deployment can potentially leak into the indoor Edge cell radii. In this type of situation, if the Edge nodes on the indoor deployments have the combination of the remote RU as well as integrated RU, then the UE can pushed towards the remote RU as it moves towards the outdoor deployment, and then transition seamlessly to outdoor RUs.
(4) HO procedure when UL is imbalanced before HO—typically, the HO procedures are based on Downlink only measurement reporting. The Downlink measurement reporting should be sufficiently aggressive to make sure the Handover occurs before the uplink starts to become imbalanced and begins to see problems.
(5) Idle and Connected State Load Balancing—this is the Load Balancing that is described hereinabove and in more detail below.

The main problem that the present methods and apparatus solve is hosting UEs in the optimal gNB split option which include all UEs to be associated to a specific split option. The two main criteria for deciding which split option architecture to use are: (a) Network jitter and latency that can affect a specific split option mode of operation of a gNB; and (b) Resource constraints that prompt the necessity for sharing of user profiles across different options provided by the access network. In some embodiments, the criteria may also include “performance” criteria, meaning “throughput” and latency. For example, assume an object or something is in the line-of-sight between a selected UE and the selected UE's associated remote RU (the remote RU currently being used by the selected UE), and further assume that the UE is streaming video. The interference caused by the object in the line-of-sight between the selected UE and the associated remote RU can be reduced or completely accounted for by moving the functionality performed by the currently used remote RU to another remote RU that has a clearer line-of-sight to the selected UE. This thereby improves the throughput to the selected UE. Performance can be measured as throughput, user throughput, and also the quality of experience (latency). In some embodiments, latency, jitter and throughput are the main criteria that are used to measure the quality experienced by the users and their respective UEs.

Description with Technical Advantages and Benefits Provided by the Present Split Option Switching Methods and Apparatus

A given CU integrates with both the Option 2 and the Option 6 split options—The Option 2 split is considered at a “higher” part of the link layer, and the Option 6 split is considered at a lower part of the link layer. The RUs may comprise anything. For example, the RUs may comprise CAT-A (outdoor) or CAT-B (indoor) CBSDs.

Heterogenous deployments that include both indoor and outdoor APs are accommodated by the present split option switching methods and apparatus. In this context, the term “heterogenous deployments” comprise deployments wherein the radio footprint or coverage of the deployed network has an umbrella-type shape. These include deployments wherein the outdoor CAT-A and indoor CAT-B antennas have considerable overlapping radio coverage. There is a heavy overlap of the outdoor with the indoor radio footprint coverage at the edges of the deployments.

In some embodiments, registration with the SAS is performed based on the required channel allocation for the option 2 and option 6 split options—associated with the RU node (RRU or integrated RU+DU). Therefore, in these embodiments, registration with the SAS is the same for both split option 2 and split option 6.

This disclosure describes an exemplary approach of switching a UE context between split option 2 (integrated DU and RU) and split option 6 (DU and Remote-RU (RRU)). Both split option 2 and split option 6 can comprise either CAT-A or CAT-B CBSDs.

### Net Adaptor Tool

In some embodiments, a Network Adaptor Tool is the tool that determines when to perform the split option switching between a first split option and a second split option. The Network Adaptor Tool provides the information necessary to trigger when to consider performing the split option switching. The fundamental paradigm of shifting either a gNB operation or a user profile is necessitated by an adaptor tool that tracks the required resources. The network adaptor tool works in a client and server architecture wherein the peers sit in every gNB of a cluster and the Edge Node 120 associated to the cluster, which comprises the network deployment at a customer site. In some embodiments, this could either be an indoor or outdoor customer site.

In some embodiments, the Network Adaptor Tool input the following measurements to determine when to make a change in the split-option switching currently being used by a deployed network. These measurements and network attributes used in some embodiments for consideration by the Network Adaptor Tool are set forth in detail in the following paragraphs:

Periodically setting up “beacons” to measure the latency and delay bandwidth product of the underlying network. In this context, the “beacons” comprise periodic transmissions of a “known” packet to assess the delays and the delay bandwidth product in the underlying network. Specifications and standards define certain baseline requirements for network delays and jitter. As a consequence, this is something that needs to be constantly monitored to ensure that the minimum baseline requirements are met, and to ensure that the minimum Quality of Experience is met for the users. If there is a problem encountered in the network in a specific area, then split option switching may be necessitated to alleviate these problems.

Assessing and determining the resource constraints on the edge node and the associated gNB. These resource constraints include CPU and memory resources. Presently, “KPIs” are used to track the CPU and memory resources (in order to collate and conclude).

Determining a Quality of Experience aggregate as seen by the users and identified by the edge node and the associated gNB in the form of “end-to-end latency”. Currently, KPIs are developed or are being developed to measure this Quality of Experience aggregate.

Block error rates experienced by different classes of users in different gNBs, and packet loss rates tracked at the edge node. Policy requirements of the network—this is essentially set forth in the form of the Microslice and exposed to the customer in their network.

The next input to the Network Adaptor Tool is an all-encompassing factor in decision making. The algorithm generates outputs in non-real time. As noted in the additional advantages sections set forth below, insights are provided into near real-time possibilities and the advantages that this idea supports. It should be noted that what the Network Adaptor Tool is tracking are not time-critical time-sensitive factors/measurements. Rather, the Network Adaptor Tool tracks factors and measurements on a “Packet-level” basis. It does this to understand the traffic modelling of the entire network at that instant in time. This is why the measurements monitored by the Network Adaptor Tool are sometimes referred to as “non-real-time” monitoring of measurements.

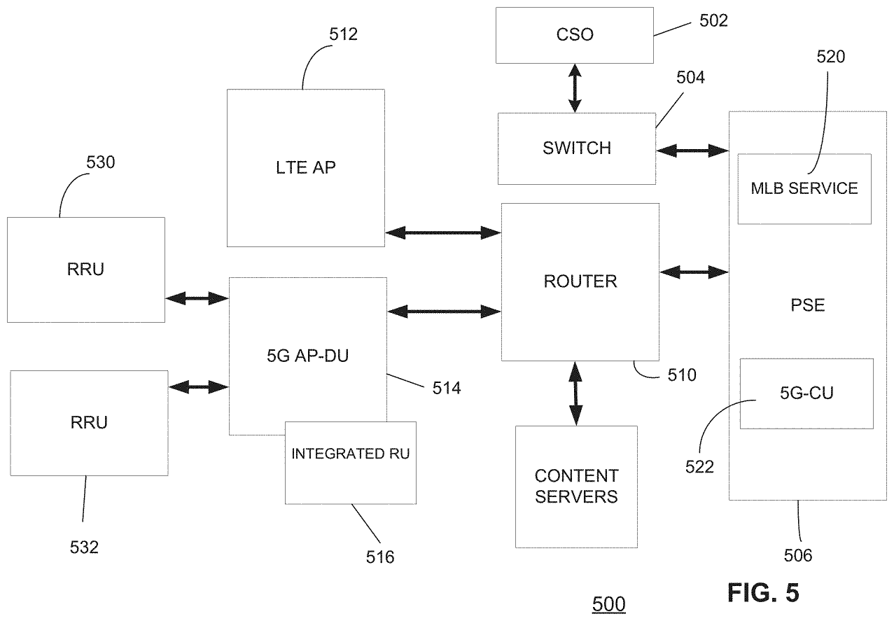

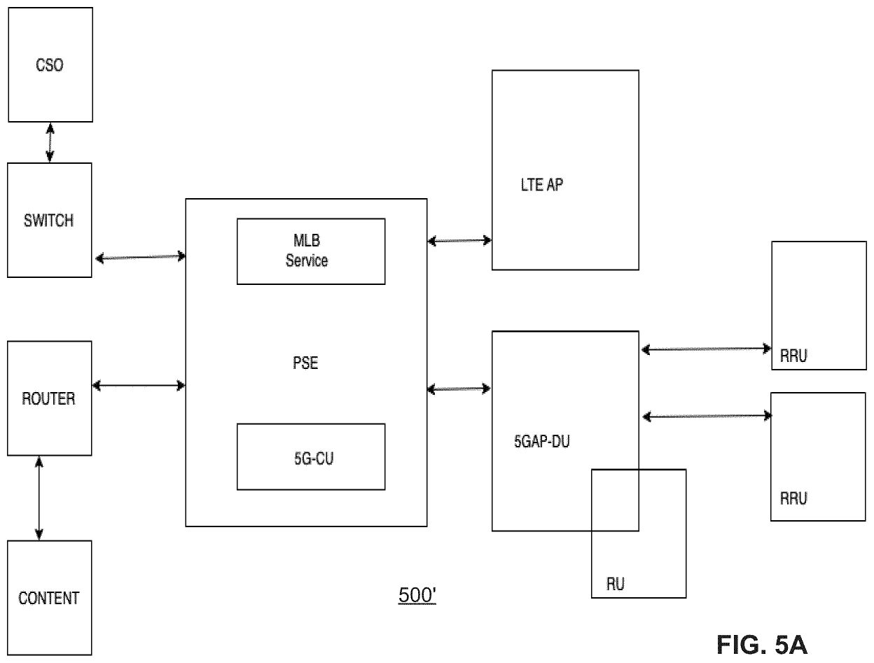

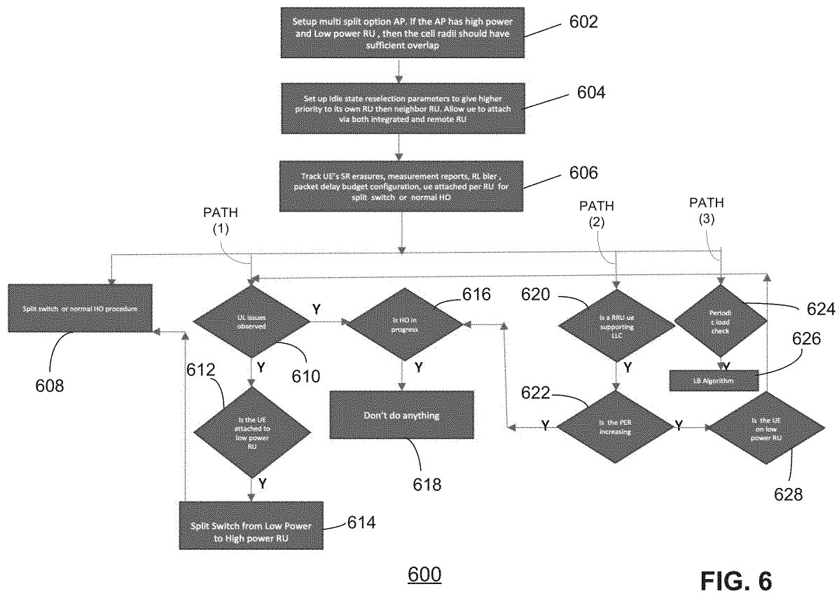

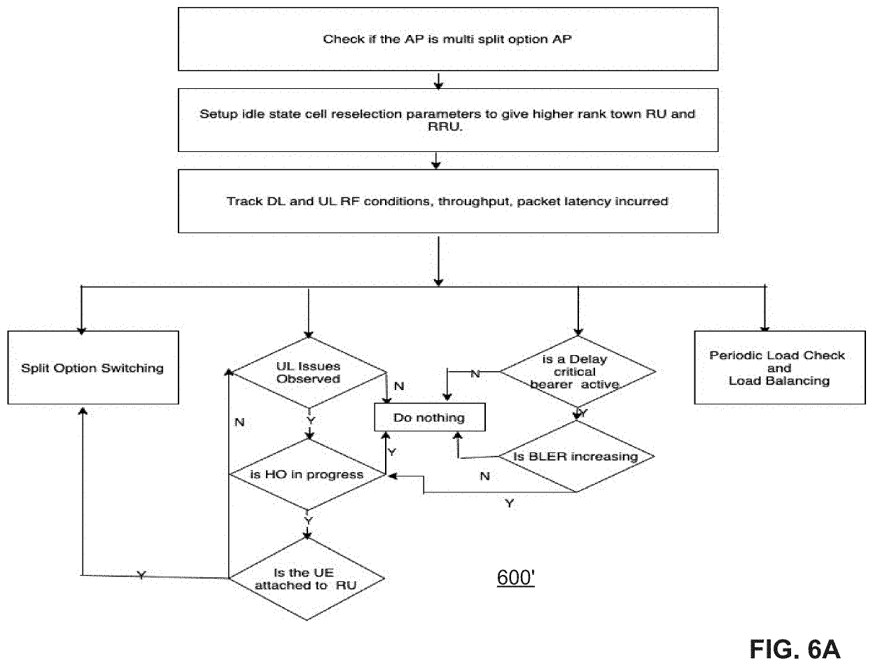

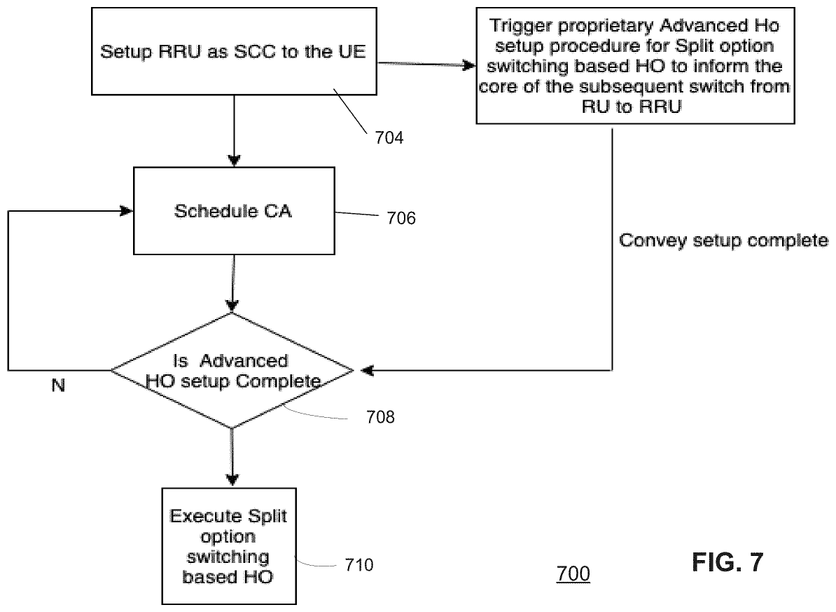

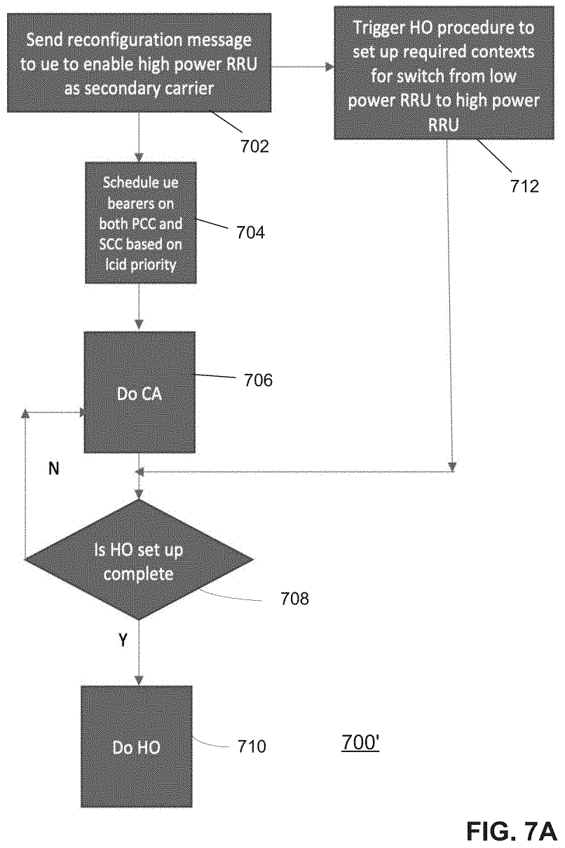

The accompanying diagrams (FIGS. 5-7, and particularly the flowcharts of FIGS. 6-7A) describe the decisions that the network adaptor tool makes. It either involves access networks being integrated at specific central AP in a cluster, or it offloads the access network's functions to the Edge Node 120.

It should be noted that no prior art deployments use a Network Adaptor Tool to make split-option-switching decisions. It should also be noted that other measurements/criteria could (and may) be used to make the determination of when to perform split-option-switching. The measurements/criteria described herein are exemplary only. No matter what measurements and criteria are used, the decision of whether or not to perform split-option switching is dynamic, based on the output/decisions of the Network Adaptor Tool described above.

Split-Option Switching Vs. Normal Handovers

Split-option-switching is a terminology used to reference a moving of the UE context across (DU+RU/DU+RRU)s integrated into a common CU. It is a handover triggered by the QoS and the enterprise wireline network conditions. Essentially, it is a network assisted Handover (HO). In contrast, a “Normal Handover”, is triggered by RF conditions experienced by the UE. This is the classical mobile-assisted HO. The benefit of implementing the Split-Option Switching HO feature is adaptation to enterprise wireline variabilities by absorbing the fluctuations in the radio layers.

### Additional Advantages of the Present Split-Option Switching Methods and Apparatus

The present split-option switching methods and apparatus provide further details on near real-time possibilities that could be addressed during the ongoing lifetime of a specific set of split options considering the central AP example (centrally integrated AP version) described above. It mainly considers the co-existence of option 6 and option 2. This can also be used and potentially be addressed to support option 7.2 provided the necessary network infrastructure is in place to support the high speed necessities of split option 7.2. Near real-time possibilities that could be addressed during the ongoing lifetime of specific set of split options considering the central AP example mentioned are listed below:

Split option switching can assist in traffic management in an indoor deployment and help increase the cell radius. Multi split-option APs can be intelligently placed in the wireless network. A UE moving away from the cell center towards the edge can potentially be picked up by the same CU-DU's remote RU, thus assuring continuum of traffic flow to the greatest extent possible.

Split option switching can assist in Handover while moving from indoor to outdoor and vice versa. The remote RRU of the indoor edge AP can maintain and support an intermediate switch step from where handover is initiated to the outdoor AP. That is both from the integrated to the remote RU of the indoor and from the remote RU of the indoor moving away to the outdoor, so the Remote RU acts as some type of staging AP.

HO for intra CU from low power CBSD and high power CBSD should consider reverse link BLER and SR erasures which could necessitate the split-option switching (network assisted handovers). This network architecture also supports mobility and idle mode load balancing.

### Methods and Apparatus—Both Hardware and Software

Solution 1—CA/DC: CA==“Carrier Aggregation” and DC==“Dual Connectivity”. A specific use case of CA (Carrier Aggregation) is described. The carrier aggregation is adopted as an intermediate stage of a specific action triggered by the split option switching in this embodiment. Wherein, if there is an imbalance, in order to make sure there is a seamless transition of a network assisted handover (HO), it takes time to ensure that the core elements are setup for the HO. Similar to a mobile assisted handover, a network assisted handover also requires the backhaul to essentially be set up to handover to a different base station. This requires certain context creation in different services associated with the PSE. So, because this requires time to set up, one solution is to revert to Carrier Aggregation in that small period of time, because the network knows where the UE is travelling to. So, if Carrier Aggregation is performed for that particular target for the small internal time, the beam is realized. Also, by using carrier aggregation, it is ensured that no packet loss occurs. It will remain autonomous to the AP and need not be driven by external management entities like SON/RIC (“RIC” is an acronym that stands for “RAN Intelligent Controller”).

The whole idea of doing CA or DC is a decision that the AP can make and that decision is not driven by external entities. Nothing needs to inform the AP of what decision to make.

Solution 2—Mobility Load Balancing (“MLB”): The solution also introduces the concept of Mobility Load Balancing as a hybrid service with the centralized piece on the Edge. The centralized aspect of the hybrid service can be viewed as an xapp in the RIC. AI aspects can be introduced. RIC is a “RAN Intelligent Controller”—essentially, a conceptual entity that has been developed by the open end standards to monitor, or act as a “parent” to and for multiple base stations, from the point of view of real-time and non-real-time network management. It is a cloud-based network architecture, so the real-time applications that manage the network are referred to as “xx” and the non-real-time applications that manage the network are referred to as “Rx”.

This load balancing paradigm does adopt a concept of centralized service that is implemented as a part of an existing load balancing feature, but steers away from the rest of the aspects.

The software design is “agnostic” to the underlying air-interface technology as it relies on parameters that are common in both—the MLB that is described herein is “agnostic” to both 4G and 5G, the hierarchical architecture of the present methods and apparatus MLB described here can potentially be viewed as one of the benefits that helps in mobility load balancing.

Private network deployment: The network will either have “under” or “over” provisioning of radio nodes. Focusing on the indoor deployments, this scheme can be used to develop multiple solutions of managing the link budget which may not be immediately visible during planning and commissioning. Assuming either an over-provisioned scenario or an under-provisioned scenario in the deployment, RF planning is used to implement the network deployment. The present split option switching methods and apparatus can support RF planning. In one aspect, the support of RF planning is implemented by intelligently replacing the multi-integrated solutions in the network to help manage the link budget.

Neutral Host Deployment: In an indoor enterprise deployment that hosts a MOCN architecture with a MNO, this scheme will potentially help in seamless handover from Enterprise to MNO networks at the edges. This is due to two aspects which have been described above when the UE transitions from the indoor network to the outdoor network. Potentially, in some embodiments, the edge AP in the enterprise could host a remote high powered RRU and switch all the split option 2 UEs on the edge AP (integrated RU) to split option 6, and hence, support better success at handover as the cell radius of edge AP would increase. The MOCN is the MNO. This covers situations where the MNO coverage does not abut the Enterprise Network coverage. This addresses both walk-in and walk-out of an enterprise neutral host for a UE.

### Exemplary Network Deployment—Network Architecture Design—with 5G Split-Option Switching Support Example

FIG. 5 shows a block diagram of an exemplary network deployment 500 that can be used in implementing the present split-option splitting methods and apparatus. As shown in the exemplary network deployment 500 of FIG. 5, the network 500 includes a CSO 502 communicating via a switch 504, and the switch communicates with a PSE 506. The PSE communicates to one or more Routers 510 (there can be more than a single router 510 in any network deployment, a single router is shown for purposes of simplicity). The Router (or Routers) 510 communicate with the LTE AP 512 and the 5G AP-DU 514 which may include an integrated RU 516. The PSE 506 handles Microslicing, etc., and sending the data towards the LTE AP 512. The PSE 506 includes the MLB service 520 and the 5G-CU 522. The exemplary deployment shows the integrated option (integrated 5G AP-DU 514 with an integrated RU 516) with two remote (RRUs) 530 and 532. The network 500 of FIG. 5 is just one of many exemplary network deployments 500. Many other network deployments 500 can be used to practice the present split option switching methods and apparatus. For example, the network deployment 500′ of FIG. 5A can be used in practicing the present methods and apparatus.

Split option switching can help in traffic management in an indoor deployment and help increase the cell radius. Multi-split option APs can be intelligently placed in the network. A UE going away from the cell center towards the edge can potentially be picked up by the same CU-DU's remote RU, thus assuring continuum of traffic flow to the greatest extent possible. Split option switching can help in handover while moving from indoor to outdoor and vice versa. The remote RRU of the indoor edge AP can support an intermediate switch step from where handover is initiated to the outdoor AP. HO for intra CU from low power CBSD and high power CBSD should consider reverse link BLER and SR erasures. This network architecture also supports mobility and idle mode load balancing.

### Software

FIG. 6 shows an exemplary software flowchart of a method that can be used in implementing the split-option switching methods and apparatus of the present disclosure. All aspects of the flow chart remain the same in the scenario where a DU supports similar power integrated RU and remote RU except that the concept of HO from low power to High power and the invocation of CA (Carrier Aggregation) to help with that handover will not be performed by the software. DU will have knowledge of the TX powers associated with its RU. The entire solution will have a-priori knowledge to ensure registrations happen properly considering a combo of DU-RU as a cell.

It is shown that four (4) aspects are tracked continuously by the software (this includes already existing handover algorithms and load balancing). Corresponding actions and decision making is described. There is an aspect brought into the flow chart called “UL issues observed”. This captures the UL instability issues observed in situations where DL measurement events are not generated or are generated by HO is not triggered.

The entire paradigm of the flowchart shown in FIG. 6 shows how the software works in some embodiments to implement the presently disclosed split option switching methods and apparatus. The three top blocks (602, 604, and 606) constantly run (are executed by) on the BS/AP. These three top blocks are the three requisite blocks. Block 602—set-up multi-split option AP. If the AP has high power and low power RUs, then the cell radii should have sufficient overlap. This is necessary to avoid dropped calls or communications. Even if one has an abutting cell, it is possible to continue to experience dropped calls. The chances of dropping calls still exist if you have abutment because there can be other RUs belonging to another CU wherein the other RUs have similar power. The network components and solutions are intelligently placed to ensure that the advantages provided by the present methods and apparatus are realized.

Block 604—Set up idle state rejection parameters to give higher priority to its own RU than to neighboring RUs. This block 604 allows UEs to attach via both integrated and remote RUs (RRUs).

Block 606—As shown in the flow diagram 600 of FIG. 6, at block 606 the UEs' Scheduling Request erasures are tracked. Scheduling Request (SR) erasures are essentially requests that the UE sends to the base station to provide resources as a grant in uplink to send data. In addition, at block 606 the UE's measurement reports of downlink power, RL (“reverse link”) BLER, packet delay budget configuration, UE attached per RU for split switch or normal HO are also all tracked. The top three blocks 602, 604, and 606 are a constantly running service on the BS/AP to track these aspects.

Then, periodically, the following items shown below “PATHs (1), (2) and (3)” are periodically monitored.

At a Block 610 (path (1)), Up Link UL issues are periodically checked. The UE, the RRU UE, the software knows that the UE is attached to an RRU or not, if the UE is attached to an RRU it is a simple change that basically tracks the RU that the UE is associated with for any UL issues. This can include low latency, or a low latency bearer. A third aspect that is checked is load balancing.

If block 610 indicates that UL issues exist, the flow moves from the block 610 to the block 616 to check to see if a handover (HO) is in progress. If an HO is in progress, then we do nothing (see block 618). At a block 612, the software (as set forth in the flowchart 600) checks to see if the UE is attached to a low power RU. If it is, a split option switch is invoked to split switch from the low power RU to a high power RU at the block 614.

If there are no low latency bearers that are associated with an RRU then the packet error rate seen by the low latency bearers is checked. Packet error rates mean the IP packet error rate which essentially translate to packet losses. If there are packet losses we check at block 616 (path 2) whether an HO is in progress. If so, no action is taken.

If an HO is not in progress, then the UE is checked to see if it is connected to a low power RRU. If it is on low power RRU, the flowchart checks to again to see if UL issues are being observed. It then follows the same process as described above.

A second scenario that is periodically checked is shown as “PATH (2)” in FIG. 6. As shown in FIG. 6, at the block 620, the software checks to see if the RRU UE is supporting LLC. At the block 622 the software checks to see if the PER is increasing. If so, it proceeds to the block 616 to see if an HO is in progress. The remainder of the software proceeds as shown in the flowchart 600 of FIG. 6.

So there are these three paths in the flowchart 600 of FIG. 6 that are checked periodically that may trigger split-option switching:
(Path 1) At block 610 determine whether UL (Up Link) issues are being observed;
(Path 2) If there is a RRU (remote RU) hosting a delay latency bearer (is an RRU UE supporting LLC as shown in the block 620); and
(Path 3) Load balancing.

So these are the three Paths that the disclosed method periodically checks in order to determine whether or not to perform split-option switching.

HO Procedure from Low Power RU to High Power RU

FIG. 7 shows an exemplary software flowchart 700 showing the HO procedure when handing over from a low power RU to a high power RRU. FIG. 7A shows an exemplary software flowchart 700′ showing an HO procedure when handing over from a low power RRU to a high power RRU. The flowcharts 700 and 700′ are very similar to each other.

As shown in FIG. 7A, at a Block 704, UE bearers are scheduled on both the Primary Component Carrier (PPC) and the Secondary Component Carrier (SCC) based on logical carrier id (“lcid”) priority. Carrier Aggregation is performed at a block 706. The flow then moves to block 708 to determine if the HO setup in the backhaul is complete. If it is complete, then the Handoff (HO) is performed at block 710. If not, then the software returns to the block 706 and keep performing carrier aggregation (CA).

### Load Balancing

The following paragraphs describe load balancing techniques and methods that can be used to implement the load balancing functions of the present Split Option Switching Methods and Apparatus. The description of these embodiments are exemplary only, and does not limit the scope of the present methods and apparatus.

Enterprise Load Balancing—Introduction

Active and Idle state load balancing not only help in alleviating the impact of unpredictable scenarios of presence of sustained traffic across multiple users (by ensuring QoE on a per user basis to the extent possible), but also help in maintaining accessibility. Need for load balancing algorithms have been further emphasized due to the time varying nature of UE mobility. There is a potential of incidental un-evenness of data traffic in a deployed network. The presence of load balancing does not preclude the necessity for admission and bearer control to be setup across all access points.

The rate requirements across all users accessing a specific set of applications should be less than or equal to the cumulative set of resources set aside for rate-sensitive traffic across all the AP in that enterprise network. As noted above, the accessibility KPI is the key and load balancing algorithms should ensure that it remains unaffected either during post or during transition of load (translating to understanding the max rise over thermal that the AP can withstand due to this network-initiated feature). The rate of load balancing should also be considered and changed as per predictive analytics across the network.

Load Balancing Algorithm—Actors

There is a necessity to maintain a centralized distribution approach for administration and operational management of load balancing. It can be perceived that centralized “active” entity sits in the edge infrastructure that not only updates its database with updates from the Aps associated to the edge infrastructure but also ensures it distributes the information back to the Apps. So, the potential actors are the MLB service in the PSE, or the MLB module in the SON service and the APs associated with the PSE. In some embodiments, the periodic information distribution would include neighbor list updates and MLB blacklist information.

The centralized service would update each AP with its neighbors periodically, and the neighbor list update would be provided in the decreasing order of TX power.

Load Balancing Algorithm—Introduction to Attraction Coefficient

The network planning approach would ideally dictate the link budget that can be afforded between a specific cell and a specific UE that is at a certain specific distance from the cell. Even if one considers a uniform distribution of UE in a network, it is not guaranteed that the distribution would be maintained across all the AP in the network as the locations and credentials (TX power, GPS coordinates) of the APs are identified. Hence UE would not attach to the AP that is the closest. It will attach to the AP that it perceives is the strongest. This creates a necessity to envision an attraction coefficient between an UE and a AP. This is not only dictated by what the UE perceives as strongest but also by affordability of the AP (at a specific instant) to consider the UE. Since load balancing is a routine that is initiated by the Network, the attraction coefficient must ensure the chances of idle state cell reselection or active state network assisted handover increases. Hence, it is better served if it is served based on incoming UE mobility profiles.

Additional Background Information Related to Load Balancing

In a network-initiated handover paradigm, the biggest unknown is whether the HO will succeed. One approach would be to track the mobility profiles of all UE in the system to determine a likelihood of success of Handover that can be associated with every neighbor. Mobility profile will indicate that most of the UEs seem to have to come to a selected AP from this last hop. The last hop seems to present a better success chance of handover to as we have been tracking profiles periodically and this neighbor has been consistently ranked high. The above is the underlying concept to this technique.

There are 5 kinds of HO issues that must be handled and processed to deal with more prominently in network-initiated HOs: “Early”, “late”, “ping pong”, “continuous” and perhaps “incorrect Hos”.

A classical way of taking care of all five in a closed loop across all AP and central service is by creating a cost function that optimizes CIO, hysteresis, time to trigger continuously. But this implicitly means that this continuous monitoring and change must also be upper bounded by max Doppler layer that can be processed. In one embodiment, a solution is independent of Doppler.

Attraction Coefficient Creation

The AP can potentially track UE mobility profile on a per UE basis. This is facilitated by the presence of the UE History Information IE in the transparent source to target container during normal handover procedures. This IE provides the mobility profile of every UE and hence gives an indirect understanding of the neighbor cells.

In some embodiments, the following is envisioned when implementing the creation of the Attraction Coefficient in software. This information is stored in the UE context as and when any UE hands in from another DU or CU. It has an ordered list of handover transitions that the UE has traversed. Periodically, the top-most Cell in the list is taken (i.e., the last cell from which the UE handed in from) of every UE. Initially, 4G APs can consider only EUTRAN cells and 5G NR APs can consider only NR cells. The neighbor cells are ranked based on the number of times they are seen.

Accordingly, in some embodiments, the Attraction Coefficient is determined by taking the following steps:
Adding the rank with the ranking results of previous 10 instants
The Higher the rank, the higher the attraction coefficient is;

In case of static devices, the load balancing target will be towards the neighbor that has the highest attraction coefficient. These devices will not be contributing towards the creation of such a coefficient.

Attraction coefficients can be decided on a per UE or per set of UE basis.

Attraction coefficients will change based, in some embodiments, on a time of day.

Mobility Load Balancing (MLB) Forbidden listing

The following description introduce three gatekeeper software in every AP that collectively decide whether MLB will be allowed by the AP. If the gatekeepers decide that MLB will not be allowed by the AP, the AP goes ahead and updates the centralized service about the same which in turn updates the other AP about the decision. This process is ongoing.

Recalculation of Bearer control upper bound is also envisioned in situations wherein the identified bearer control is rendered useless due to ongoing air-interface situations that require excessive usage to maintain GBR compliance than predicted.

In some embodiments, the gatekeepers comprise the following:
Max attached users vis-à-vis max allowed users;
GBR control upper bound and PDB compliance bound; and
ROT situation.

### Forbidden-Listing Based on ROT

In a network it is important to understand the impact of load balancing on the ROT of the cell that is the recipient of the load offload. Rise over thermal is a ratio of received power over noise floor. It ensures stability in the cell and helps in conforming the cell to a planned coverage. It is measured in the digital side.

The noise floor can get affected by multiple factors including the neighbors. So, it is important to set up a threshold that defines the situation where LNA can go into saturation. Despite the threshold, a high-level water mark needs to be considered for potential unknown fading and interference creators. An SNR threshold referred to as a “ROT” threshold is envisioned. The value of this threshold will be dictated by the following factors: Allowable WB-RSSI range for digital base band operation; and Allowable SFDR of the LNA. This information can be obtained from DVT reports and PA data sheets.

Load Balancing—Idle State Action Routine

In some embodiments, the Load Balancing Idle State Action Routine is executed according to the following steps. The AP receives periodic neighbor list updates sorted on TX power. The neighbor list updates also contain MLB forbidden-listing information. The AP creates a list based on the combined key of MLB forbidden-listing and TX power <higher TX power given higher ranking and MLB status associated to higher TX power-based ranking is considered next if there is a match of TX power>. The AP checks the consistency of the created table over previous 10 updates. The AP sets up the cell priority across inter frequency and intra frequency cell state reselection based on the created list and updates the SIB.

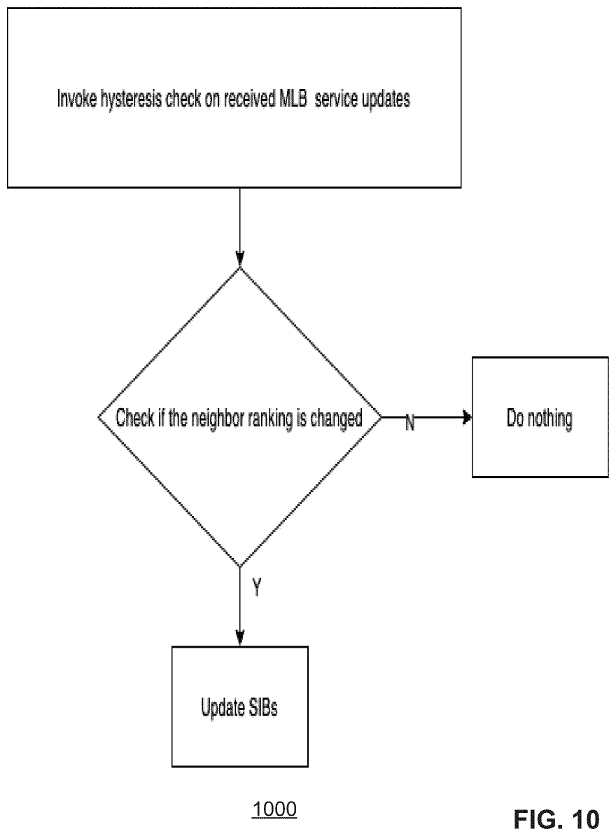

FIG. 10 shows a software flowchart for Load Balancing in an idle state MLB possible implementation. Other implementations may be used other than that shown in the flowchart of FIG. 10.

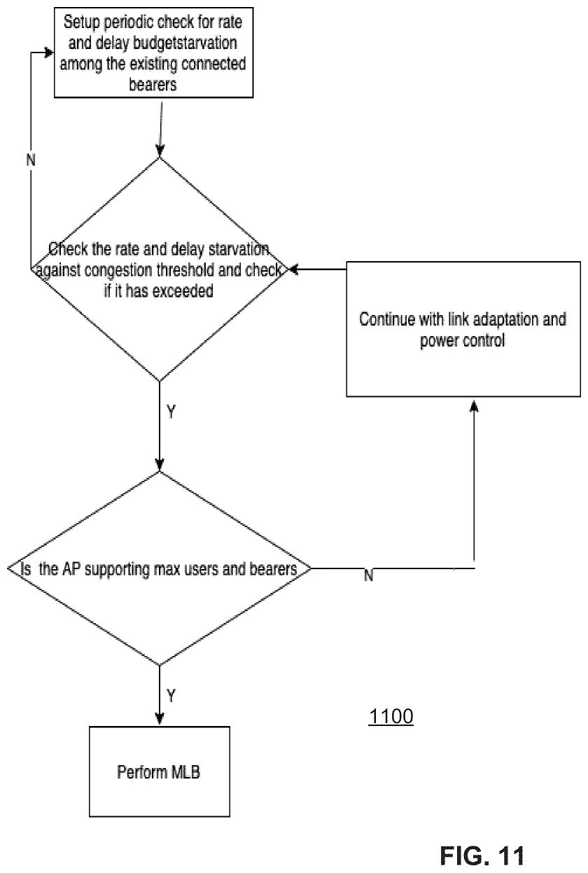

FIG. 11 shows a software flowchart for one embodiment of a Load Balancing Algorithm—Connected State MLB possibility. Other implementations may be used other than that shown in the flowchart of FIG. 11.

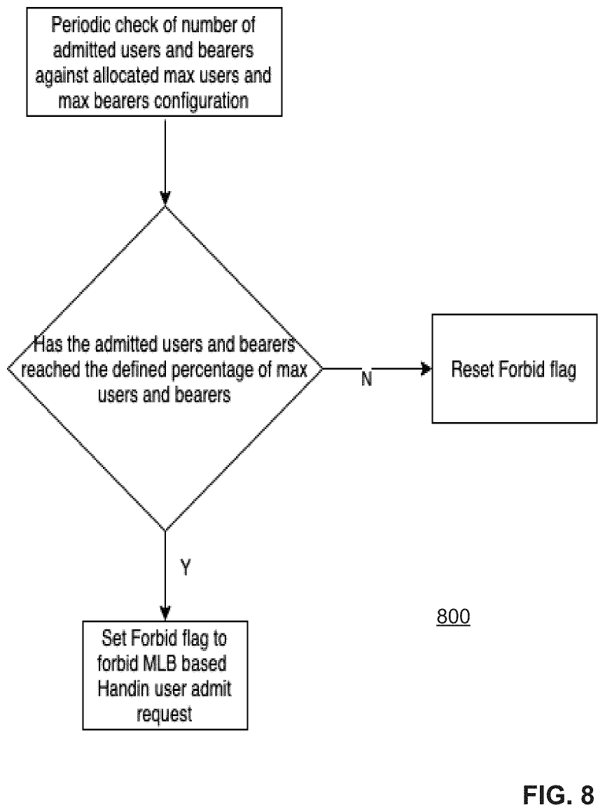

FIG. 8 shows a software flowchart for one embodiment of a Load Balancing Algorithm—the forbidden list Gatekeeper's Operational Flow chart. Other implementations may be used other than that shown in the flowchart of FIG. 8.

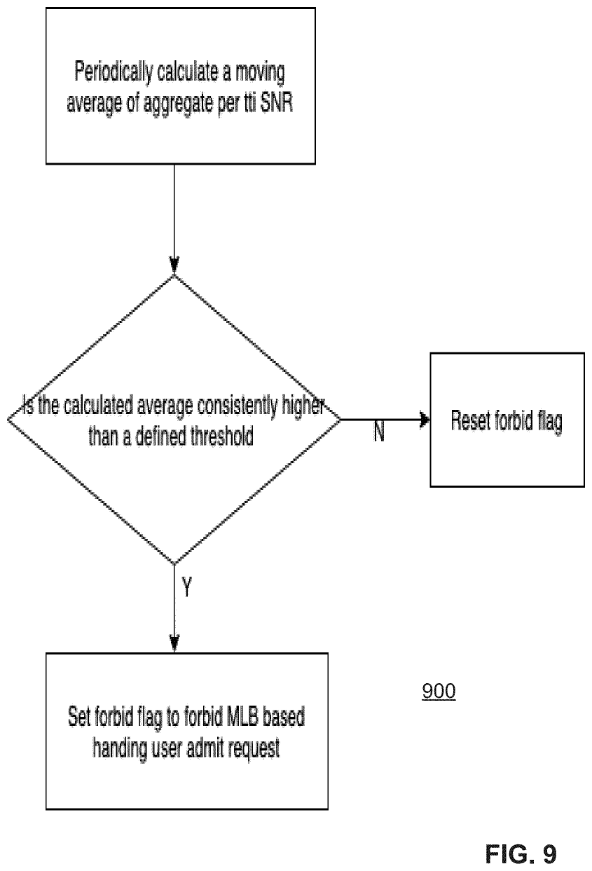

FIG. 9 shows a software flowchart for another embodiment of a Load Balancing Algorithm—the forbidden list Gatekeeper's Operational Flow chart. Other implementations may be used other than that shown in the flowchart of FIG. 9.

Load Balancing—Connected State Action Routine

In some embodiments, the Load Balancing Connected State Action Routine is executed according to the following steps:
The AP receives periodic neighbor list updates sorted on TX power;
The neighbor list updates also contain MLB forbidden-listing information;
The AP would potentially be getting measurement event information from different UE (but not yet triggered HO);
The AP periodically calculates attraction coefficient;
Once the load balancing possibility is seen, the action routine works in the following manner:
   Attraction coefficient is used in moving UE contexts across RRU as a part of split option switching or to another DU under the realm of load balancing in case UE has not generated any event;
   If the UE has generated an event within an identified delta time prior to the trigger condition of load balancing, that neighbor is given precedence for triggering split switch across RRU or HO across DU; and
   Both the above consider blacklisting before initiating action.

### CONCLUSION

Methods and apparatus to dynamically perform split-option switching of architectures of wireless networks based on real-time and non-real-time measurements and inputs wherein, the split-option architectures are switched to optimize user equipment (UE) experiences and network performance have been disclosed.

Although the disclosed method and apparatus is described above in terms of various examples of embodiments and implementations, it should be understood that the particular features, aspects and functionality described in one or more of the individual embodiments are not limited in their applicability to the particular embodiment with which they are described. Thus, the breadth and scope of the claimed invention should not be limited by any of the examples provided in describing the above disclosed embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described with the aid of block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. An apparatus used in implementing split option switching in an Enterprise Wireless network, comprising:
a) a first architectural variant of an AP, integrated through a central AP, wherein the first architectural variant comprises a fully integrated first RU, in combination with a first DU and a CU first sub-variant, wherein the CU is in communication with a Core Enterprise Wireless Network via an Edge Node, a second sub-variant comprising a second RU acting in combination with a second DU, wherein the first and second DUs are controlled by the CU, and a third sub-variant comprising an RU which may comprise an RRU in communication with the first DU; and
b) a second architectural variant of an AP, having AP functionality offloaded to the Edge Node, comprising a fully integrated first RU, in combination with a first DU and a CU first sub-variant, wherein the CU is in communication with the Core Wireless Network via the Edge Node, a second sub-variant comprising a second RU acting in combination with a second DU, and a third sub-variant comprising a third RU which may comprise an RRU in communication with the Edge Node, wherein the CU controls all three of the sub-variants of the second architectural variant of the AP; and
c) wherein the Enterprise Wireless Network is implemented using either the first or second architectural variants of the AP, and wherein the wireless network further comprises a plurality of UEs coupled to a plurality of the APs via one of the RUs in the APs, and wherein the UEs are dynamically switched between the plurality of RU/DU and CU nodes as the UEs move throughout the Enterprise Network, and wherein the UEs are seamlessly transitioned across the plurality of RU/DU and CU nodes based upon the Quality of Experience provided by the plurality of UEs to their respective users.

2. The apparatus used in implementing split option switching in an Enterprise Wireless network of claim 1, wherein the second sub-variants of both the first and second architectural variants implement functionality of Split-Option 6.

3. The apparatus used in implementing split option switching in an Enterprise Wireless network of claim 1, wherein the third sub-variant of the first architectural variant implements functionality of Split-Option 7.2 x, wherein “x” strands for either “a” or “b”.

4. The apparatus used in implementing split option switching in an Enterprise Wireless network of claim 1, wherein the UEs each have associated UE contexts that are maintained for each of the UEs by the Enterprise Wireless Network, and wherein the context of any UE transitioning from a selected first sub-variant to a selected second subvariant is transitioned to the selected second sub-variant and maintained therein.

5. The apparatus used in implementing split option switching in an Enterprise Wireless network of claim 1, wherein the Enterprise network includes a plurality of CU and DU nodes, and wherein instances of the CU and DU nodes are dynamically moved within the wireless network to improve the Quality of Experience provided by the plurality of UEs.

6. The apparatus used in implementing split option switching in an Enterprise Wireless network of claim 1, wherein functionality of the RU, DU and CU nodes closest to a selected UE are implemented in order to improve network performance.

7. The apparatus used in implementing split option switching in an Enterprise Wireless network of claim 6, wherein the wireless network is dynamically adapted to meet the needs of the UEs and improve Quality of Experience provided to the plurality of users.

8. The apparatus used in implementing split option switching in an Enterprise Wireless network of claim 1, wherein the performance of the Wireless network is determined by measuring latency and load balancing within the wireless network, wherein load balancing refers to balancing the number of UEs handled by any one selected architectural variant.

9. The apparatus used in implementing split option switching in an Enterprise Wireless network of claim 1, wherein performance of the Wireless network is based upon latency, user throughput, and jitter measurements.

10. The apparatus used in implementing split option switching in an Enterprise Wireless network of claim 9, wherein the latency, user throughput, and jitter measurements comprise the main criteria used to measure the Quality of network performance experienced by the plurality of users and their respective UEs.

11. The apparatus used in implementing split option switching in an Enterprise Wireless network of claim 1, wherein a selected node is optimized for power, and wherein some of the functionality of the selected node is dynamically transferred to the Edge Node in order for the selected node to accommodate additional UEs and additional users.

12. The split option switching apparatus used in implementing split option switching in an Enterprise Wireless network of claim 1, wherein the apparatus resolves the following issues associated when dynamically switching a 5G access network to support operation across different possible network architecture splits:
a) call continuum in an indoor environment without handover; and
b) increasing cell radius in environments where fading and interference margins are not constant, wherein the CU controls all three of the sub-variants of the second architectural variant of the AP;
c) call continuum across indoor and outdoor enterprise networks when there is adjacent deployment of the indoor and outdoor enterprise networks;
d) performing a Handover (HO) procedure when the uplink is imbalanced before performing the HO procedure; and
e) performing idle and connected State Load Balancing wherein the loads of UEs selected architectural variants are balanced.

13. The split option switching apparatus used in implementing split option switching in an Enterprise Wireless network of claim 12, wherein the following criteria are used to determine which split option switching architecture to use:
a) Network jitter and latency affecting a selected split option switching architecture; and
b) Resource constraints that prompt a necessity to share a plurality of user profiles across the different split option architectures.

14. The apparatus used in implementing split option switching in an Enterprise Wireless network of claim 1, wherein the Enterprise Wireless network comprises heterogenous enterprise network deployments, wherein the heterogenous enterprise network deployments include both indoor and outdoor wireless networks using both indoor and outdoor APs.

15. The apparatus used in implementing split option switching in an Enterprise Wireless network of claim 14, wherein the RUs comprise both outdoor CAT-A antennas CBSDs and indoor CAT-B CBSDs.

16. The apparatus used in implementing split option switching in an Enterprise Wireless network of claim 1, wherein a Network Adaptor Tool is used to determine when to perform split option switching between the first architectural variant and the second architectural variant.

17. The apparatus used in implementing split option switching in an Enterprise Wireless network of claim 16, wherein the Network Adaptor Tool tracks network resources and inputs the following network measurements to make the determination of when to perform split option switching:
a) network latency and delay bandwidth product measurements of an underlying wireless network;
b) resource constraints on the Edge Node and associated APs, wherein the resource constraints include constraints on CPU and memory resources;
c) Quality of Experience (QoE) aggregate measurements as manifest to a plurality of users of the wireless network, wherein the QoE aggregate measurements comprise end-to-end latency measurements; and
d) Block error rates by different classes of the plurality of users of the plurality of APs.

18. The apparatus used in implementing split option switching in an Enterprise Wireless network of claim 17, wherein the network measurements provided as input to the Network Adaptor Tool are performed on a packet-level basis, and wherein the measurements comprise non-real time measurements and do not comprise time-critical or time-sensitive measurements.

19. A method of implementing split-option switching of network resources in an Enterprise wireless network, wherein the Enterprise wireless network includes a plurality of APs, and wherein a plurality of users communicate with the plurality of APs using UEs connected to selected RUs of the APs, and wherein the APs comprise RU, CU and DUs arranged as alternative split-option architectural variants, comprising:
a) instituting the APs as multi-split option APs, and determining whether the multi-split option APs include both low power and high power RUs;
b) setting up idle state rejection parameters for the plurality of APs, wherein the idle state rejection parameters provide a higher priority for an RU of a a selected AP versus RUs of neighboring APs, and wherein UEs are allowed to communicate with both integrated and remote RUs of the selected AP;
c) tracking UE Scheduling Request (SR) erasures, UE measurement reports of downlink power, Reverse Link (RL) BLERs, and packet delay budget configurations; and
d) attaching UEs to the APs via the RUs associated with the plurality of APs, and tracking the attachment of UEs to the plurality of APs.

20. The method of claim 19, further comprising periodically monitoring Uplink issues associated with uplink communications from the plurality of UEs to the APs.

21. The method of claim 20, further comprising monitoring the UEs to determine if a selected UE is attached to a low power RU, and if so, performing split option switching to attach the selected UE to a high power RU.

22. The method of claim 19, further comprising periodically monitoring the UEs and associated APs to determine if RRUs of the associated APs are hosting low latency bearers, and if so further monitoring whether packet error rates (PERs) of the associated APs are increasing, and if so, checking to see if a HO is in process and if an HO is not in process performing split option switching to attach the selected UE to a high power RU.

23. The method of claim 19, further comprising periodically monitoring load balancing of UE loads between different split-option architectural variants.

24. The method of claim 23, further comprising periodically implementing load balancing methods to balance the load of UEs on the different split-option architectural variants.

25. The method of claim 24, wherein the load balancing methods include active state and idle state load balancing methods, and wherein the active state and idle state load balancing methods alleviate an impact of uneven data traffic within the enterprise wireless network.
